(19) United States
(12) Patent Application Publication
(10) Pub. No.: US 2010/0244427 A1
(43) Pub. Date: Sep. 30, 2010

(54) Thing to do planner

(76) Inventor: Fred W. Coble, North Hills, CA (US)

Correspondence Address: Fred W. Coble, 8745 Valjean Ave., North Hills, CA, 91343, US

(21) Appl. No.: 12/383,574

(22) Filed: Mar. 26, 2009

(51) Int. Cl. B42D 5/04

(52) U.S. Cl. 283/3

(57) ABSTRACT

A plastic, metal, wood, or molded glass unit used to handily and visibly display a number of written plans, duties, appointments, responsibilities, and things to remember on card stock such as 3×5 index cards, preferably sorted in order of priority. Said unit to be configured for mounting on a vertical plane such as a wall space, or positioned on a horizontal surface, such as desk tops and tables, and embodying a storage compartment for holding a supply of cards, and writing instrument.

### BRIEF DESCRIPTION OF THE DRAWING

FIG. 1 is a front view of the Things To Do Planner, demonstrating its principle-operating feature of accepting memo cards.

FIG. 2 provides an alternate construction methodology.

FIG. 3 shows a sectional view to exhibit the card placement.

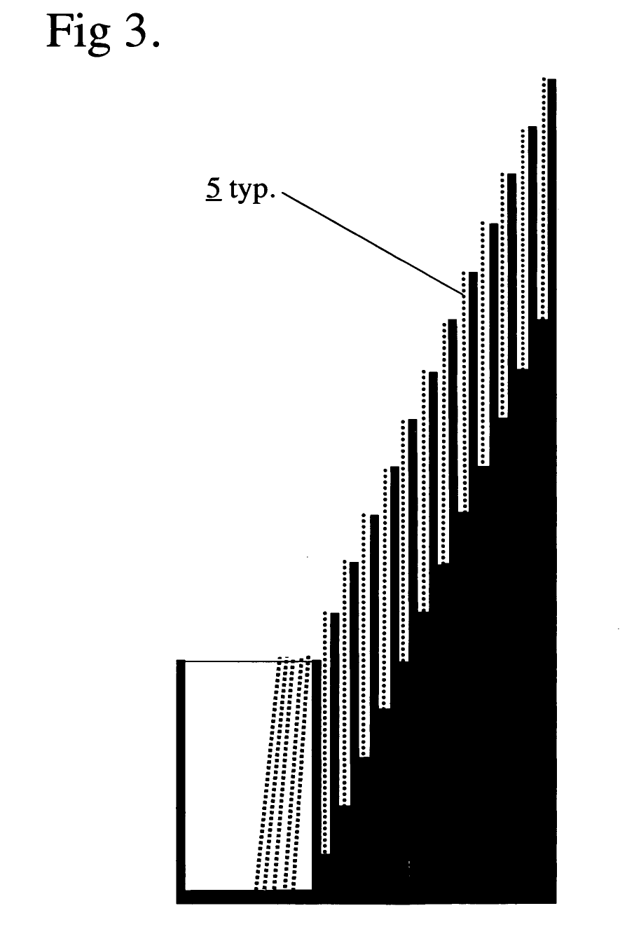

### DETAIL DESCRIPTION OF THE PLANNER

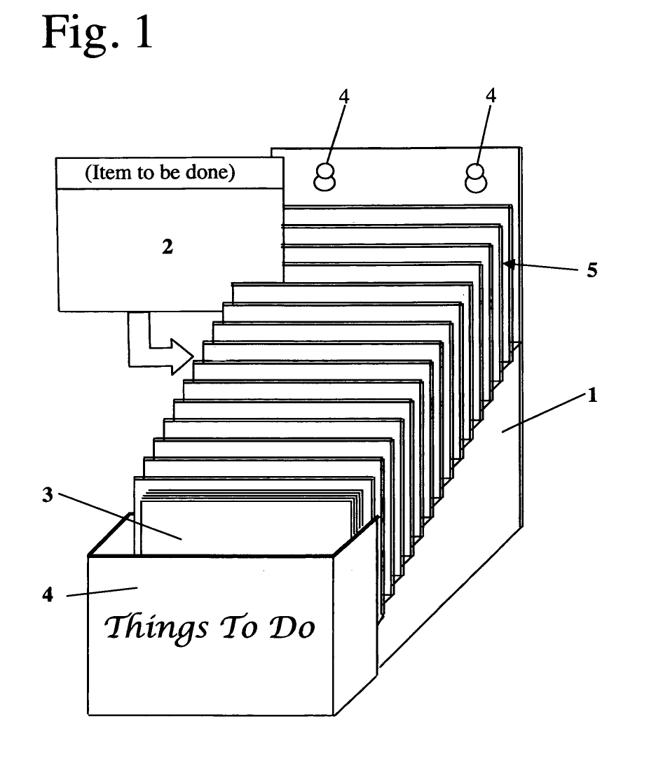

FIG. 1 THINGS TO DO PLANNER 1 is designed to hold a number of hard-stock paper cards 2, such as 3×5 index cards; each with hand written titles in plain sight, and arranged in the rack in order of their priorities. The Planner is at about 9″H×5″W×4″D; may be hung on a wall 4 or positioned on a surface, in a viewable location. A non-skid material is cemented to the bottom surface. Cards 2 are made readily accessible for adding information, prioritizing, and carrying when attempting to do the doing things written thereon.

The Planner is fabricated via injection-plastic molding, poured into pottery moulds, carved via laser, or die-cast in aluminum.

There are at least 12 card slots 5 about a tenth of an inch thick, two and a half inches deep, and 5 inches wide.

Box 3, attached to the lower front of the planner, holds blank cards and writing instruments. Surface 4 is available for attaching a timepiece, or POST-IT sheets.

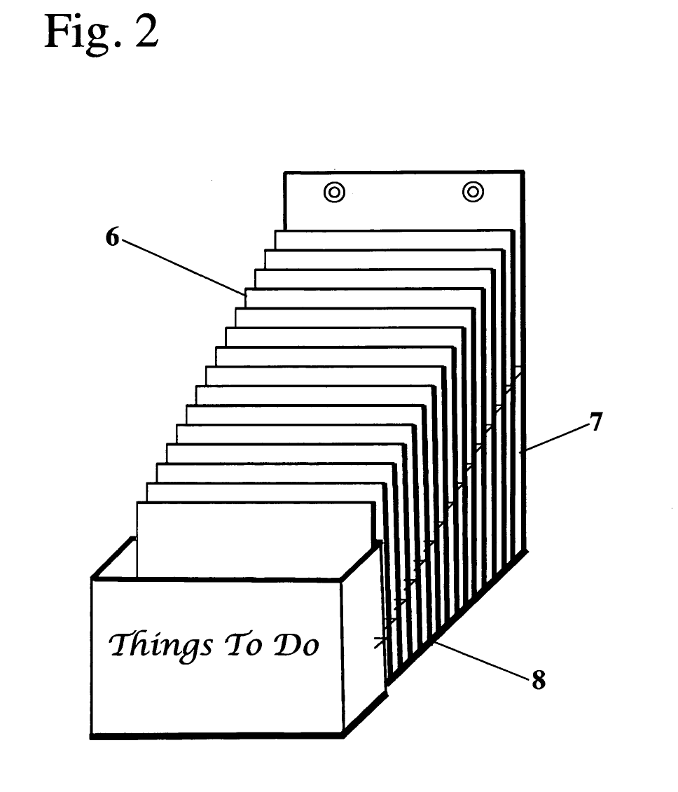

FIG. 2 illustrates an alternate method of construction in which the card-slot-panels 6 are individual sheets of Plexiglas, metal, or plywood. Panel with separators 7 of like material, and measuring in varying heights to insure all card slots are at least two and a half inches deep. A bottom sheet 8 of like material serves as a base plate, and is accessible for suitable surface padding.

1. A Planner/Reminder unit of plastic, metal, pottery clay, or glass, wood, configured for sorting and displaying, in priority order, at least 12 index cards, containing and showing THINGS TO DO, written across the top of the cards. Said cards are made readily accessible for adding related data, and for carrying along when making an effort to do the things that need to be done. The unit measures about 9 inch tall 5 inches wide, and 4 and a half inches deep, occupying less than one fifth of a square foot when positioned on a horizontal surface.

2. Said display unit is fabricated via plastic injection molding, potter-clay pouring into plaster of Paris molds, aluminum die-casting, laser sculpturing, or by cementing segments together to form the unit. All fabrications being conducive to the full spectrum of colors.

3. Said unit provides card slots about a tenth of an inch allowing up to ten cards pertaining to a single subject matter.
